(19) United States
(12) Patent Application Publication
(10) Pub. No.: US 2015/0034225 A1
(43) Pub. Date: Feb. 5, 2015

(54) REINFORCED NON-PNEUMATIC TIRE AND SYSTEM FOR MOLDING REINFORCED NON-PNEUMATIC TIRE

(71) Applicant: CATERPILLAR INC., PEORIA, IL (US)

(72) Inventor: KEVIN L. MARTIN, WASHBURN, IL (US)

(73) Assignee: CATERPILLAR INC., PEORIA, IL (US)

(21) Appl. No.: 13/954,504

(22) Filed: Jul. 30, 2013

(51) Int. Cl. B60C 7/10; B29C 70/84

(52) U.S. Cl. CPC B60C 7/10; B29C 70/84; B60C 2007/005; B60C 2007/107
USPC 152/326; 425/500; 264/261

(57) ABSTRACT

A non-pneumatic tire may include an inner circumferential portion configured to be coupled to a hub, and an outer circumferential portion radially spaced from the inner circumferential portion. The tire may further include a support structure extending between the inner circumferential portion and the outer circumferential portion and coupling the inner circumferential portion to the outer circumferential portion. The support structure may at least partially define a first axial side of the tire and a second axial side of the tire opposite the first axial side of the tire. The support structure may have a plurality of cavities at least partially extending between the first axial side of the tire and the second axial side of the tire, and at least some of the cavities may be reinforced with a synthetic reinforcing material.

### TECHNICAL FIELD

The present disclosure relates to tires and systems for molding tires, and more particularly, to reinforced non-pneumatic tires and systems for molding reinforced non-pneumatic tires.

### BACKGROUND

Machines such as vehicles, either self-propelled or pushed or pulled, often include wheels for facilitating travel across terrain. Such wheels often include a tire to protect a rim or hub of the wheel, provide cushioning for improved comfort or protection of passengers or cargo, and provide enhanced traction via a tread of the tire. Non-pneumatic tires have been used for machines as an alternative to pneumatic tires. Non-pneumatic tires may be relatively less complex than pneumatic tires because they do not retain air under pressure. However, non-pneumatic tires may suffer from a number of possible drawbacks. For example, non-pneumatic tires may be relatively heavy and may not have a sufficient ability to provide a desired level of cushioning. For example, some non-pneumatic tires may provide little, if any, cushioning, potentially resulting in discomfort to passengers and/or damage to cargo. In addition, some non-pneumatic tires may not be able to maintain a desired level of cushioning when the load changes on the tire. In particular, if the structure of the non-pneumatic tire provides the desired level of cushioning for a given load, it may not be able to continue to provide the desired level of cushioning if the load is changed. Moreover, for non-pneumatic tires that provide an acceptable level of cushioning, the radial compliance of the tires may result in exceeding the stress and strain limits of the material used to form the tires. Exceeding the stress or strain limits of the material may lead to cracking or a reduced service life of the tire.

An example of a cushioned tire that is not inflated is disclosed in U.S. Pat. No. 2,620,844 to Lord (“the '844 patent”). In particular, the '844 patent discloses a cushioned tire formed from a resilient material such as rubber. The tire includes a rigid inner rim shaped to be mounted on a wheel, an outer continuous tread section formed of resilient material such as rubber, and a cushion formed of resilient material extending between and connected to the rim and tread section. The cushion of the tire is provided by openings that extend from one side to the other of the tire and are formed by walls which extend around the tire, with the walls being formed to transmit loads that act radially between the rim and tread.

Although the cushioned tire disclosed in the '844 patent provides cushioning, it may suffer from a number of drawbacks sometimes associated with non-pneumatic tires. For example, the tire disclosed in the '844 patent may not be able to maintain a desired level of cushioning when the load on the tire changes. In addition, achieving the desired level of cushioning may result in exceeding the stress and strain limits of the material forming the tire. Therefore, it may be desirable to provide a non-pneumatic tire that mitigates or overcomes one or more of these possible drawbacks.

The non-pneumatic tire disclosed herein may be directed to mitigating or overcoming one or more of the possible drawbacks set forth above.

### SUMMARY

According to a first aspect, the present disclosure is directed to a non-pneumatic tire. The non-pneumatic tire may include an inner circumferential portion configured to be coupled to a hub, and an outer circumferential portion radially spaced from the inner circumferential portion. The tire may further include a support structure extending between the inner circumferential portion and the outer circumferential portion and coupling the inner circumferential portion to the outer circumferential portion. The support structure may at least partially define a first axial side of the tire and a second axial side of the tire opposite the first axial side of the tire. The support structure may have a plurality of cavities at least partially extending between the first axial side of the tire and the second axial side of the tire, and at least some of the cavities may be reinforced with a synthetic reinforcing material.

According to a further aspect, a system for molding a non-pneumatic tire may include a lower mold portion including a lower face plate configured to provide a lower relief corresponding to a first side of the tire, and a plurality of lower projections extending from the lower face plate and configured to correspond to cavities in the first side of the tire. The system may further include an upper mold portion configured to be coupled to the lower mold portion. The upper mold portion may include an upper face plate configured to provide an upper relief corresponding to a second side of the tire, and a plurality of upper projections extending from the upper face plate and configured to correspond to cavities in the second side of the tire. The system may also include synthetic reinforcing material associated with at least some of the plurality of lower projections and the plurality of upper projections, wherein the synthetic reinforcing material is configured to reinforce at least some of the cavities of the tire.

According to a further aspect, a method of forming a molded non-pneumatic tire may include providing a lower mold portion including a lower face plate configured to provide a lower relief corresponding to a first side of the tire, and a plurality of lower projections extending from the lower face plate and configured to correspond to cavities in the first side of the tire. The method may further include providing an upper mold portion including an upper face plate configured to provide an upper relief corresponding to a second side of the tire, and a plurality of upper projections extending from the upper face plate and configured to correspond to cavities in the second side of the tire. The method may also include associating synthetic reinforcing material with at least some of the lower projections and upper projections, and placing the upper mold portion onto the lower mold portion to create a mold assembly having an interior. The method may further include heating a molding material and transferring the heated molding material into the interior of the mold assembly, such that the interior is substantially filled. The method may also include curing the heated molding material. The method may further include separating the upper mold portion from the lower mold portion, and separating the tire from the lower mold portion, such that the synthetic reinforcing material remains in the tire following separation of the tire from the lower and upper mold portions.

### BRIEF DESCRIPTION OF THE DRAWINGS

FIG. 1 is a side view of an exemplary embodiment of a machine including an exemplary embodiment of a non-pneumatic tire.

FIG. 2 is a perspective view of an exemplary embodiment of a non-pneumatic tire.

FIG. 3 is a partial section view of an exemplary embodiment of a non-pneumatic tire.

FIG. 4 is a side view of an exemplary embodiment of a non-pneumatic tire.

FIG. 5 is a schematic exploded view of an exemplary embodiment of a system for molding a non-pneumatic tire.

FIG. 6 is a partial perspective section view of an exemplary embodiment of a system for molding a non-pneumatic tire.

FIG. 7 is a cross-sectional view of an exemplary embodiment of a sleeve.

FIG. 8 is a partial perspective section view of another exemplary embodiment of a system for molding a non-pneumatic tire.

### DETAILED DESCRIPTION

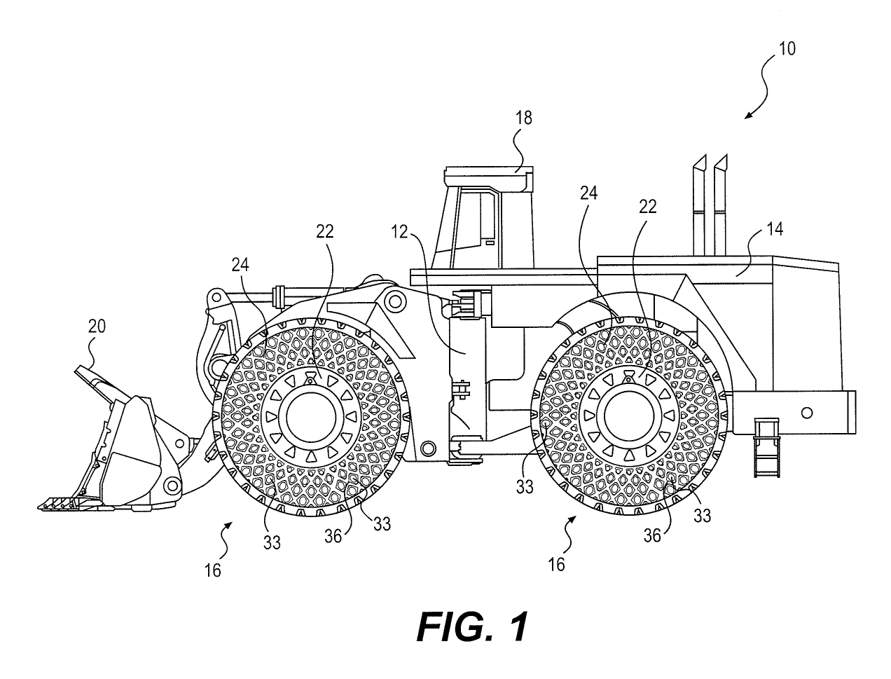

FIG. 1 shows an exemplary machine 10 configured to travel across terrain. Exemplary machine 10 shown in FIG. 1 is a wheel loader. However, machine 10 may be any type of ground-borne vehicle, such as, for example, an automobile, a truck, an agricultural vehicle, and/or a construction vehicle, such as, for example, a dozer, a skid-steer loader, an excavator, a grader, an on-highway truck, an off-highway truck, and/or any other vehicle type known to a person skilled in the art. In addition to self-propelled machines, machine 10 may be any device configured to travel across terrain via assistance or propulsion from another machine.

Exemplary machine 10 shown in FIG. 1 includes a chassis 12 and a powertrain 14 coupled to and configured to supply power to wheels 16, so that machine 10 is able to travel across terrain. Machine 10 also includes an operator station 18 to provide an operator interface and protection for an operator of machine 10. Machine 10 also includes a bucket 20 configured to facilitate movement of material. As shown in FIG. 1, exemplary wheels 16 include a hub 22 coupled to powertrain 14, and tires 24 coupled to hubs 22. Exemplary tires 24 are molded tires, such as, for example, molded, non-pneumatic tires.

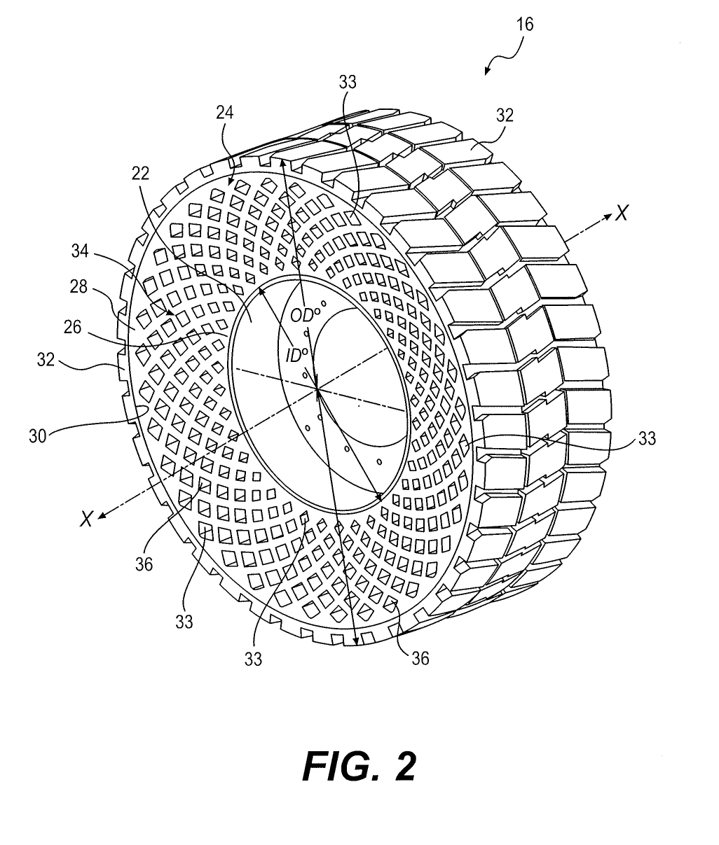

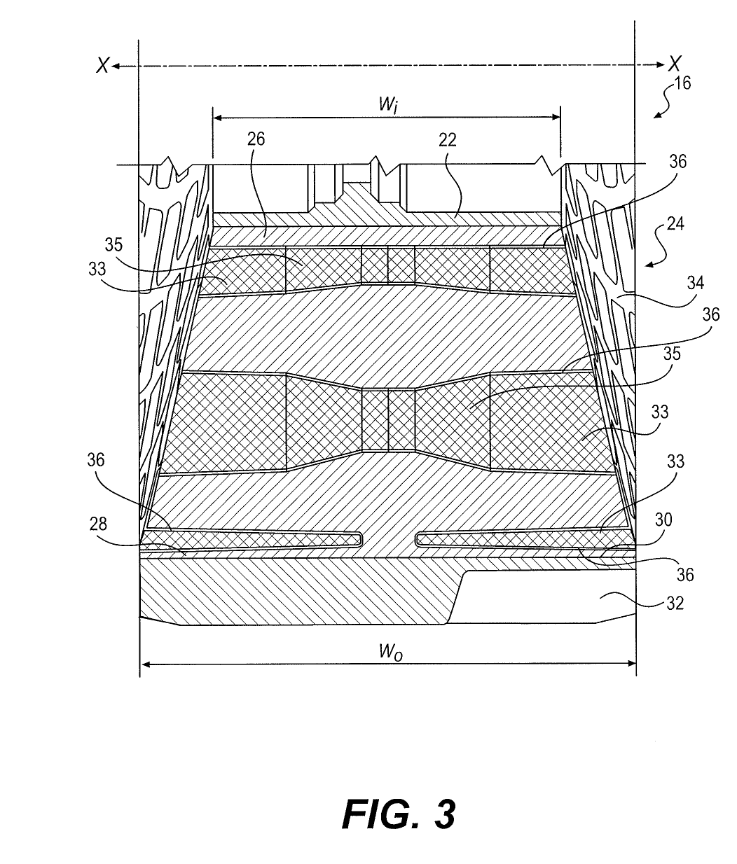

The exemplary tire 24 shown in FIGS. 2 and 3 includes an inner circumferential portion 26 configured to be coupled to a hub 22, and an outer circumferential portion 28 configured to be coupled to an inner surface 30 of a tread portion 32 configured to improve traction of tire 24 at the interface between tire 24 and the terrain across which tire 24 rolls. Extending between inner circumferential portion 26 and outer circumferential portion 28 is a support structure 34. Exemplary support structure 34 serves to couple inner circumferential portion 26 and outer circumferential portion 28 to one another. As shown in FIGS. 1-4, exemplary tire 24 includes a plurality of cavities 33 configured to provide support structure 34 with a desired level of support and cushioning for tire 24. According to some embodiments, one or more of cavities 33 may have an axial intermediate region 35 (FIG. 3) having a relatively smaller cross-section than the portion of cavities 33 closer to the axial sides of tire 24.

According to some embodiments, one or more of inner circumferential portion 26 and outer circumferential portion 28 are part of support structure 34. Hub 22 and/or inner circumferential portion 26 may be configured to facilitate coupling of hub 22 to inner circumferential portion 26. According to some embodiments, support structure 34, inner circumferential portion 26, outer circumferential portion 28, and/or tread portion 32 are integrally formed as a single, monolithic piece, for example, via molding. Tread portion 32 and support structure 34 may be chemically bonded to one another. For example, the material of tread portion 32 and the material of support structure 34 may be covalently bonded to one another. According to some embodiments, support structure 34, inner circumferential portion 26, and/or outer circumferential portion 28 are integrally formed as a single, monolithic piece, for example, via molding, and tread portion 32 is formed separately in time and/or location and is joined to support structure 34 in a common mold assembly to form a single, monolithic piece. Even in such embodiments, tread portion 32 and support structure 34 may be chemically bonded to one another. For example, the material of tread portion 32 and the material of support structure 34 may be covalently bonded to one another.

Exemplary tire 24, including inner circumferential portion 26, outer circumferential portion 28, tread portion 32, and support structure 34, may be configured to provide a desired amount of traction and cushioning between a machine and the terrain. For example, support structure 34 may be configured to support the machine in a loaded, partially loaded, and empty condition, such that a desired amount of traction and/or cushioning is provided, regardless of the load.

For example, if the machine is a wheel loader as shown in FIG. 1, when its bucket is empty, the load on one or more of wheels 16 may range from about 60,000 lbs. to about 160,000 lbs. (e.g., 120,000 lbs.). In contrast, with the bucket loaded with material, the load on one or more of wheels 16 may range from about 200,000 lbs. to about 400,000 lbs. (e.g., 350,000 lbs.). Tire 24 may be configured to provide a desired level of traction and cushioning, regardless of whether the bucket is loaded, partially loaded, or empty. For smaller machines, correspondingly lower loads are contemplated. For example, for a skid-steer loader, the load on one or more of wheels 16 may range from about 1,000 lbs. empty to about 3,000 lbs. (e.g., 2,400 lbs.) loaded.

Tire 24 may have dimensions tailored to the desired performance characteristics based on the expected use of the tire. For example, exemplary tire 24 may have a rotational axis X, an inner diameter ID for coupling with hub 22 ranging from 0.5 meters to 4 meters (e.g., 2 meters), and an outer diameter OD ranging from 0.75 meters to 6 meters (e.g., 4 meters) (see FIG. 2). According to some embodiments, the ratio of the inner diameter of tire 24 to the outer diameter of tire 24 ranges from 0.25:1 to 0.75:1, or 0.4:1 to 0.6:1, for example, about 0.5:1. Support structure 34 may have an inner axial width Wᵢ at inner circumferential portion 26 (see FIG. 3) ranging from 0.05 meters to 3 meters (e.g., 0.8 meters), and an outer axial width Wₒ at outer circumferential portion 28 ranging from 0.1 meter to 4 meters (e.g., 1 meter). For example, exemplary tire 24 may have a trapezoidal cross-section (see, e.g., FIG. 3). Other dimensions are contemplated. For example, for smaller machines, correspondingly smaller dimensions are contemplated.

According to some embodiments, tread portion 32 and support structure 34 are formed either separately or together from the same type of polyurethane (i.e., a polyurethane having the same material characteristics). According to some embodiments, tread portion 32 is formed from a first polyurethane having first material characteristics, and support structure 34 is formed from a second polyurethane having second material characteristics different than the first material characteristics. According to some embodiments, tread portion 32 may be chemically bonded to support structure 34. For example, at least some of the first polyurethane of tread portion 32 may be covalently bonded to at least some of the second polyurethane of support structure 34. This may result in a superior bond than bonds formed via adhesives, mechanisms, or fasteners.

In such embodiments, as a result of the first material characteristics of the first polyurethane being different than the second material characteristics of the second polyurethane, it may be possible to tailor the characteristics of tread portion 32 and support structure 34 to characteristics desired for those respective portions of tire 24. For example, the second polyurethane of support structure 34 may be selected to be relatively stiffer and/or stronger than the first polyurethane of tread portion 32, so that support structure 34 may have sufficient stiffness and strength to support the anticipated load on tires 24. According to some embodiments, the first polyurethane of tread portion 32 may be selected to be relatively more cut-resistant and wear-resistant and/or have a higher coefficient of friction than the second polyurethane, so that regardless of the second polyurethane selected for support structure 34, tread portion 32 may provide the desired wear and/or traction characteristics for tire 24.

For example, the first polyurethane of tread portion 32 may include polyurethane urea materials based on one or more of polyester, polycaprolactone, and polycarbonate polyols that may provide relatively enhanced abrasion resistance. Such polyurethane urea materials may include polyurethane prepolymer capped with methylene diisocyanate (MDI) that may relatively strongly phase segregate and form materials with relatively enhanced crack propagation resistance. Alternative polyurethanes capped with toluene diisocyanate (TDI), napthalene diisocyanate (NDI), and/or para-phenylene diisocyanate (PPDI) may also be used. Such polyurethane prepolymer materials may be cured with aromatic diamines that may also encourage strong phase segregation. Exemplary aromatic diamines include methylene diphenyl diamine (MDA) that may be bound in a salt complex such as tris(4,4′-diamino-diphenyl methane) sodium chloride (TDDM).

According to some embodiments, the first polyurethane may have a Shore hardness ranging from about from 60A to about 60D (e.g., 85 Shore A). For certain applications, such as those with soft ground conditions, it may be beneficial to form tread portion 32 from a material having a relatively harder durometer to generate sufficient traction through tread penetration. For applications such as those with hard or rocky ground conditions, it may be beneficial to form tread portion 32 from a material having a relatively lower durometer to allow conformability of tread portion 32 around hard rocks.

According to some embodiments, the second polyurethane of support structure 34 may include polyurethane urea materials based on one or more of polyether, polycaprolactone, and polycarbonate polyols that may provide relatively enhanced fatigue strength and/or a relatively low heat build-up (e.g., a low tan δ). For example, for high humidity environments it may be beneficial for the second polyurethane to provide a low tan δ for desired functioning of the tire after moisture absorption. Such polyurethane urea materials may include polyurethane prepolymer capped with methylene diisocyanate (MDI) that may strongly phase segregate and form materials having relatively enhanced crack propagation resistance, which may improve fatigue strength. Alternative polyurethanes capped with toluene diisocyanate (TDI), napthalene diisocyanate (NDI), or para-phenylene diisocyanate (PPDI) may also be used. Such polyurethane prepolymer materials may be cured with aromatic diamines that may also encourage strong phase segregation. Exemplary aromatic diamines include methylene diphenyl diamine (MDA) that may be bound in a salt complex such as tris(4,4′-diamino-diphenyl methane) sodium chloride (TDDM). Chemical crosslinking in the polyurethane urea may provide improved resilience to support structure 34. Such chemical crosslinking may be achieved by any means known in the art, including but not limited to: the use of tri-functional or higher functionality prepolymers, chain extenders, or curatives; mixing with low curative stoichiometry to encourage biuret, allophanate, or isocyanate formation; including prepolymer with secondary functionality that may be cross-linked by other chemistries (e.g., by incorporating polybutadiene diol in the prepolymer and subsequently curing such with sulfur or peroxide crosslinking). According to some embodiments, the second polyurethane of support structure 34 (e.g., a polyurethane urea) may have a Shore hardness ranging from about 80A to about 95A (e.g., 92A).

Some embodiments of tire 24 may include an intermediate portion (not shown) between outer circumferential portion 28 and inner surface 30 of tread portion 32. For example, outer circumferential portion 28 of support structure 34 may be chemically bonded to inner surface 30 of tread portion 32 via an intermediate portion.

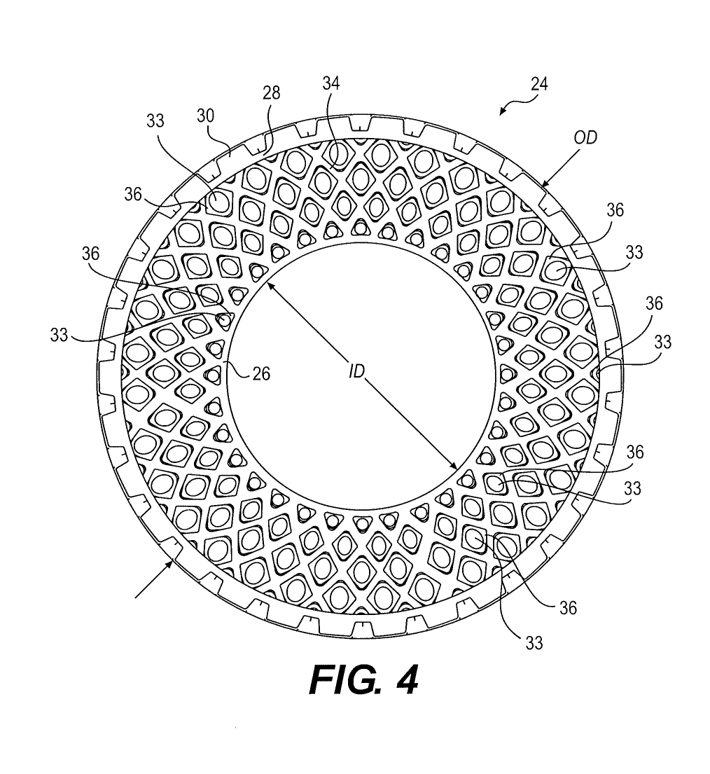

Referring to FIGS. 3 and 4, some embodiments of tire 24 may include a synthetic reinforcing material 36. For example, in the exemplary embodiments shown in FIGS. 3 and 4, at least some of cavities 33 may be reinforced with synthetic reinforcing material 36. Synthetic reinforcing material 36 may include, for example, synthetic reinforcing fibers, such as, for example, para-aramid synthetic fibers, such as poly-paraphenylene terephthalamide (e.g., KEVLAR®). According to some embodiments, synthetic reinforcing material 36 may serve to locally reinforce areas of tire 24 subjected to relatively higher stress and/or strain concentrations, while permitting tire 24 to substantially maintain a desired level of radial compliance. This may result in a tire having a desired level of cushioning without substantially compromising the durability of tire 24 (e.g., support structure 34). For example, the inner surfaces of cavities 33 may be subjected to relatively higher stress and/or strain concentrations as compared with other portions of tire 24. Synthetic reinforcing material 36 may result in cavities 33 being able to withstand such stress and/or strain concentrations.

According to some embodiments, synthetic reinforcing material 36 may be at least partially embedded in the surface of at least some of cavities 33. For example, synthetic reinforcing material 36 may be placed in the mold forming tire 24 prior to supplying the molding material into the mold. According to some embodiments, synthetic reinforcing material 36 may be adhered (e.g., via adhesive (e.g., acrylic adhesive)) to portions of the mold that form cavities 33. Thereafter, the molding material may be supplied to the mold. According to some embodiments, the molding material may impregnate synthetic reinforcing material 36, thereby at least partially permeating the material and, according to some embodiments, at least partially curing synthetic reinforcing material 36 (e.g., para-aramid synthetic fibers), such that synthetic reinforcing material 36 becomes an integral part of tire 24. According to some embodiments, synthetic reinforcing material 36 may be substantially co-extensive with the surface of at least some cavities 33.

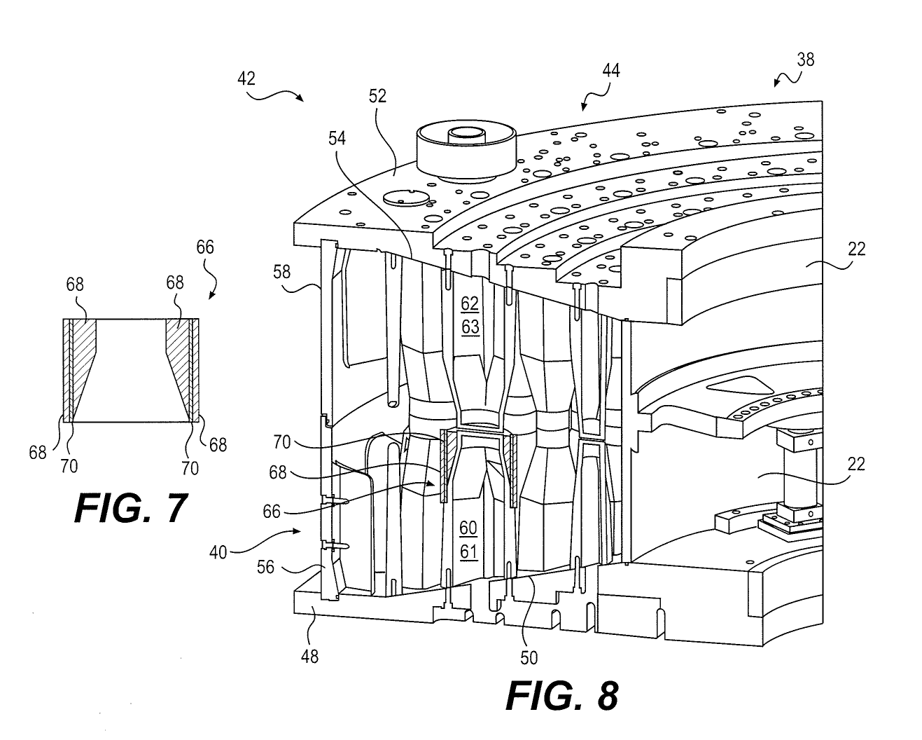

According to some embodiments, synthetic reinforcing material 36 may be below the surface of cavities 33 (i.e., a layer of the molding material may separate at least a portion of synthetic reinforcing material 36 from the surface of the respective cavity 33). For example, synthetic reinforcing material 36 may be molded into a polyurethane tube, such that a tube of synthetic reinforcing material is disposed remote from the inner diameter of the polyurethane tube (see, e.g., FIG. 7). The polyurethane tubes may be placed over the cavity-forming portions of the mold, such that the inner diameter of the polyurethane tubes is against the cavity-forming portions. Once the molding material is supplied to the mold, the polyurethane tubes become embedded in the tire with the tube of synthetic reinforcing material being remote from the surface of the respective cavity 33 (i.e., below the surface).

Synthetic reinforcing material 36 may be provided in several forms. For example, synthetic reinforcing material 36 may take the form of a woven or non-woven fabric. For such embodiments, one or more layers of the fabric may be associated with portions of the interior of the tire mold where reinforcing is desired in the tire. Adhesive (e.g., acrylic adhesive) may be used to secure the fabric in the desired locations during supply of molding material to the interior of the mold. Upon curing the tire in the mold, the adhesive may dissolve or disintegrate, such that the tire may be separated from the mold without the fabric (impregnated with the molding material) adhering to the interior of the mold. According to some embodiments, synthetic reinforcing material 36 may take the form of a sleeve (e.g., a tube having open opposite ends (e.g., a tube of para-aramid synthetic fibers (e.g., a KEVLAR® sock or sleeve))). For such exemplary embodiments, the sleeves may be mounted on the cavity-forming portions of the mold. Adhesive may or may not be used to secure the sleeves in the desired locations of the mold during the molding process.

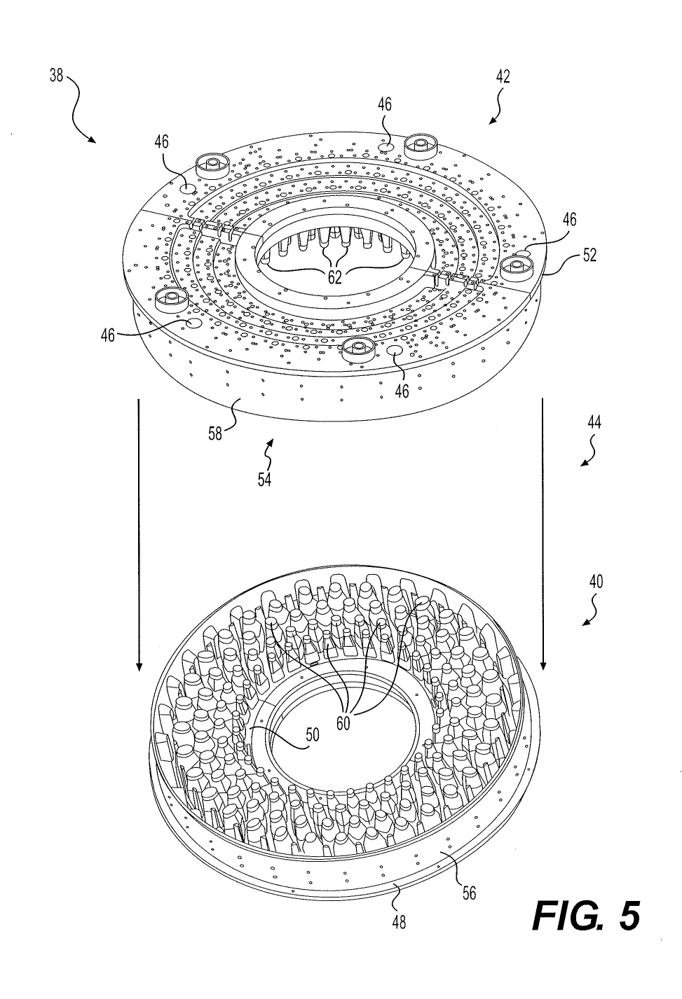

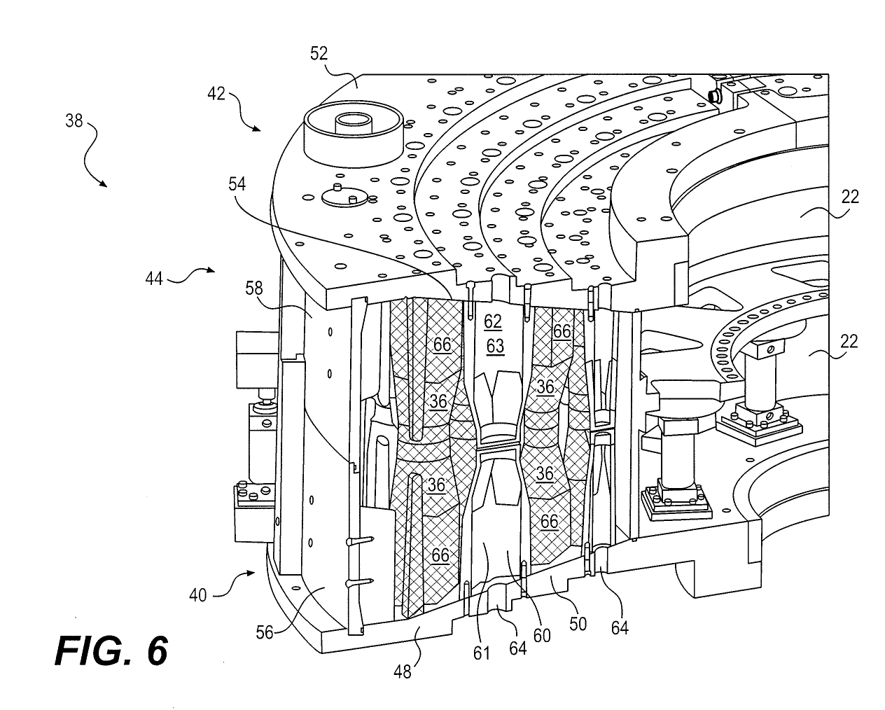

FIG. 5 schematically depicts an exemplary embodiment of a system 38 for molding a non-pneumatic tire, such as, for example, exemplary tire 24 shown in FIGS. 1-4. Exemplary system 38 includes a lower mold portion 40 and an upper mold portion 42 configured to be mounted on lower mold portion 40 to form a mold assembly 44 defining a sealed interior configured to receive a molding material. According to some embodiments, upper mold portion 42 may be mounted on lower mold portion 40 such that a hub 22 (see FIGS. 6 and 8) associated with the molded tire is received between lower mold portion 40 and upper mold portion 42. In such embodiments, the combination of lower mold portion 40, upper mold portion 42, and hub 22 form mold assembly 44 defining a sealed interior configured to receive a molding material. According to some embodiments, upon receipt of the molding material, hub 22 is molded into the molded tire.

According to some embodiments, mold assembly 44 may include a plurality of circumferentially spaced guide assemblies configured to facilitate alignment of lower mold portion 40 and upper mold portion 42. Exemplary mold assembly 44 also includes a plurality of circumferentially spaced apertures 46 configured to provide a flow path for molding material to be supplied or transferred to the interior of mold assembly 44. As a result of having a number of apertures 46 for facilitating filling of mold assembly 44, molding material may be simultaneously supplied to the interior of mold assembly 44 via apertures 46, thereby increasing the rate at which the molding material may be supplied. This may be particularly desirable if, for example, the size of the tire being molded is particularly large and requires a large volume of molding material. Increasing the rate at which the molding material is added to mold assembly 44 may result in maintaining a relatively uniform temperature of the molding material at various locations in the interior of mold assembly 44 as the molding material is supplied to molding assembly 44.

As shown in FIG. 5, exemplary lower mold portion 40 includes a lower face plate 48. According to some embodiments, lower face plate 48 may be formed from two semi-circular sections coupled to one another. Lower face plate 48 may be configured to provide a lower relief 50 corresponding to a side of the tire being molded (e.g., a first side). Similarly, exemplary upper mold portion 42 includes an upper face plate 52. According to some embodiments, upper face plate 52 may include two semi-circular sections coupled to one another. Upper face plate 52 may be configured to provide an upper relief 54 corresponding to a side (e.g., a second side) of the tire being molded opposite from the side formed by lower relief 50 of lower face plate 48. Lower face plate 48 and/or upper face plate 52 may be formed from a material having a high thermal conductivity, such as, for example, aluminum, which will facilitate heating and cooling of the molding material in the interior of mold assembly 44.

According to some embodiments, lower relief 50 and upper relief 54 may be configured such that the cross-section of the tire molded in mold assembly 44 increases with the radius of the tire. For example, the cross-section of the tire may be wider adjacent tread portion 32 than adjacent hub 22. For example, the cross-section may have a substantially trapezoidal shape (see, e.g., FIG. 3).

As shown in FIG. 5, exemplary lower mold portion 40 includes a lower circular barrier 56 coupled to lower face plate 48. Exemplary lower circular barrier 56 is substantially perpendicular to lower face plate 48 and corresponds to a portion of an outer circumferential surface of the tire being molded (e.g., tread portion 32). Exemplary upper mold portion 42 includes an upper circular barrier 58 coupled to upper face plate 52. Exemplary upper circular barrier 58 is substantially perpendicular to upper face plate 52 and corresponds to a portion of an outer circumferential surface of the tire being molded (e.g., tread portion 32).

In the exemplary embodiment shown in FIG. 5, lower mold portion 40 also includes a plurality of lower projections 60 that are coupled to and extend from lower face plate 48. Lower projections 60 are configured to create cavities (e.g., cavities 33 shown in FIGS. 1-4) in the tire molded in mold assembly 44. According to some embodiments, lower projections 60 taper as they extend from lower face plate 48. In such embodiments, the cavities formed in the molded tire are tapered, such that they have a smaller cross-section at the axially intermediate region than at the outer sides of the tire. This may facilitate removing the tire from the mold following molding and/or may provide desired performance characteristics (e.g., cushioning and support) of the tire. As shown in FIG. 5, some embodiments of lower mold portion 40 are configured to receive hub 22. In the exemplary embodiment shown, lower projections 60 are arranged around hub 22 in a number of concentric circles.

In the exemplary embodiment shown in FIG. 5, upper mold portion 42 also includes a plurality of upper projections 62 that are coupled to and extend from upper face plate 52. Upper projections 62 are configured to create cavities in the tire molded in mold assembly 44. According to some embodiments, upper projections 62 taper as they extend from upper face plate 52. In such embodiments, the cavities formed in the molded tire are tapered, such that they have a smaller cross-section at the axially intermediate region than at the outer sides of the tire. This may facilitate removing the tire from the mold following molding and/or may provide desired performance characteristics of the tire. As shown in FIG. 5, some embodiments of upper mold portion 42 have upper projections 62 that are arranged around an inner diameter of upper face plate 52 in a number of concentric circles. According to some embodiments, the concentric circles of lower mold portion 40 and the upper mold portion 42 may correspond to one another, such that at least some of the ends of lower projections 60 are aligned with at least some of the ends of upper projections 62.

As shown in FIG. 6, at least some of lower projections 60 and upper projections 62 are hollow. According to some embodiments, at least some of lower projections 60 and upper projections 62 are formed from a material having a high thermal conductivity, such as, for example, aluminum (e.g., cast aluminum). Such construction may facilitate heating and cooling of the molding material in the interior of mold assembly 44. According to some embodiments, lower face plate 48 and upper face plate 52 may include a plurality or apertures 64 that correspond to the location of at least some of lower projections 60 and upper projections 62. In such embodiments, the interiors of the hollow portions of projections 60 and 62 are in flow communication with the exterior of mold assembly 44 via apertures 64. Such construction may facilitate heating and cooling of the molding material in the interior of mold assembly 44.

According to some embodiments, at least some of lower projections 60 and upper projections 62 may be coupled to the respective interior surfaces of lower face plate 48 and upper face plate 52, for example, via fasteners such as bolts and/or adhesive. According to some embodiments, at least some of lower projections 60 and upper projections 62 or respective face plates 48 and 52 may be configured to receive an o-ring or gasket to provide a fluid seal, so that molding material does not leak from the interior of mold assembly 44 during molding.

As shown in FIG. 6, at least some of projections 60 and 62 may have cross-sections that change area and/or shape as projections 60 and 62 extend away from respective face plates 48 and 52. For example, at least some of projections 60 and 62 have a cross-section that reduces as projections 60 and 62 extend away from respective face plates 48 and 52. According to some embodiments, at least some of projections 60 and 62 have a cross-section that changes shape as projections 60 and 62 extend away from respective face plates 48 and 52. For example, as shown in FIG. 6, the cross-sections of projections 61 and 63 have both a parallelogram shape adjacent respective face plates 48 and 52, and a circular or elliptical shape at the distal ends of projections 61 and 63.

According to some embodiments, system 38 may include synthetic reinforcing material 36 associated with at least some of lower projections 60 and/or upper projections 62, such that following molding of tire 24, synthetic reinforcing material 36 reinforces at least some of cavities 33 in the molded tire (e.g., tire 24). For example, as shown in FIG. 6, synthetic reinforcing material 36 includes sleeves 66 including synthetic reinforcing fibers (e.g., sleeves of para-aramid synthetic fibers (e.g., sleeves of poly-paraphenylene terephthalamide (e.g., KEVLAR® socks))). As shown in FIG. 6, some embodiments of sleeves 66 are configured to be mounted over at least some of lower projections 60 and upper projections 62 (i.e., over at least some lower projections 60 and/or at least some upper projections 62). According to some embodiments, sleeves 66 cover only a portion of lower projections 60 and/or upper projections 62. According to some embodiments, sleeves 66 substantially cover (e.g., fully cover) lower projections 60 and/or upper projections 62.

According to some embodiments, sleeves 66 are configured such that upon molding of the tire, at least a portion of synthetic reinforcing material 36 is separated from the surface of a respective cavity 33 by a layer of the molding material. For example, as shown in FIG. 7 exemplary sleeves 66 are configured such that the synthetic reinforcing material 36 is below the surface of cavities 33 following molding of the tire. For example, synthetic reinforcing material 36 may be molded into a tube 68 (e.g., a tube of polyurethane or similar material), such that a tube 70 of synthetic reinforcing material 36 is disposed remote from the inner diameter of tube 68. Tubes 68 may be placed over lower projections 60 and/or upper projections 62 (e.g., cavity-forming portions) of mold assembly 44, such that the inner diameter of tubes 68 is against lower and/or upper projections 60 and 62. According to some embodiments, the inner diameter of tubes 68 may be configured to correspond to (e.g., mirror the shape of) the outer diameter of the lower and upper projections 60 and 62. Once the molding material is supplied to mold assembly 44, tubes 68 become embedded in tire 24, with tube 70 of synthetic reinforcing material 36 being remote from the surface of a respective cavity 33 (i.e., below the surface). According to some embodiments, sleeves 66 may include only synthetic reinforcing material 36 without any other structure.

FIG. 8 shows exemplary system 38 including exemplary sleeves 66 including tube 68 and tube 70 of synthetic reinforcing material 36 (e.g., the exemplary sleeves 66 shown in FIG. 7). As shown in FIG. 8, some embodiments of sleeves 66 shown in FIG. 7 are configured to be mounted over at least some of lower projections 60 and upper projections 62 (i.e., over at least some lower projections 60 and/or at least some upper projections 62). According to some embodiments, sleeves 66 shown in FIG. 7 may cover only a portion of lower projections 60 and/or upper projections 62 (e.g., as shown in FIG. 8). According to some embodiments, sleeves 66 shown in FIG. 7 may substantially cover (e.g., fully cover) lower projections 60 and/or upper projections 62.

According to an exemplary method, a molded, non-pneumatic tire (e.g., exemplary tire 24) may be formed by providing lower mold portion 40, including lower face plate 48, lower circular barrier 56, and lower projections 60, and further, by providing upper mold portion 42, including upper face plate 48, upper circular barrier 58, and upper projections 62. Synthetic reinforcing material 36 may be associated with at least some of lower projections 60 and/or some of upper projections 62. For example, associating synthetic reinforcing material 36 with at least some of lower and upper projections 60 and 62 may include mounting synthetic reinforcing material 36 on at least some of lower and upper projections 60 and 62. For example, synthetic reinforcing material 36 may include sleeves 66 including synthetic reinforcing fibers, and the method may further include sliding sleeves 66 over at least some of lower and upper projections 60 and 62. According to some embodiments, sleeves 66 may include tube 68 (e.g., a tube of polyurethane or similar material) with synthetic reinforcing fibers (e.g., tube 70 of synthetic reinforcing fibers) at least partially embedded in tube 68. According to some embodiments, mounting synthetic reinforcing material 36 may include securing synthetic reinforcing material 36 to at least some of lower and upper projections 60 and 62 via adhesive.

Thereafter, upper mold portion 42, including upper face plate 52 and upper circular barrier 58, may be coupled to lower mold portion 40 to create mold assembly 44. The molding material (e.g., polyurethane or similar material) may be heated, and the heated molding material may be transferred into the interior of mold assembly 44 via apertures 46, such that the interior of mold assembly 44 is substantially filled. Thereafter, the molding material may be cured by heating, and upon cooling thereafter, upper mold portion 42 may be separated from lower mold portion 40, and the molded tire may be separated from lower mold portion 40, such that synthetic reinforcing material 36 remains in the tire following separation of the tire from lower mold portion 40.

According to some embodiments, when the molding material is transferred to the interior of mold assembly 44, it at least partially permeates reinforcing material 36, at least partially curing synthetic reinforcing material 36 as an integral feature of the molded tire. For example, synthetic reinforcing material 36 may be at least partially embedded in cavities 33 of the molded tire.

The method may include placing lower mold portion 40 on a device such as a cart that facilitates movement of lower mold portion 40. According to some embodiments, the surfaces of the interior of lower mold portion 40 may be treated with a mold release agent to reduce the likelihood of portions of the molded tire from adhering to lower mold portion 40. Similarly, the surface of the interior of upper mold portion 42 may be treated with a mold release agent.

According to some embodiments, for example, embodiments in which hub 22 forms a seal with lower mold portion 40 and/or upper mold portion 42, hub 22 may be placed in lower mold portion 40, such that a seal between hub 12 and lower mold portion 40 is formed. Upper mold portion 42 may be lowered onto lower mold portion 40, such that upper mold portion 42 and hub 22 engage one another in a sealed manner to form mold assembly 44.

According to some embodiments, mold assembly 44 may be heated prior to receiving the molding material. This may assist with preventing a portion of the molding material from cooling too quickly as the heated molding material contacts portions of the interior of mold assembly 44. According to some embodiments, mold assembly 44 may be moved into an oven for heating, for example, via a cart on which lower mold portion 40 may be located. According to some embodiments, mold assembly 44 may be heated at from 150° C. to 200° C. (e.g., 180° C.) for from 2 to 3 hours (e.g., 2.5 hours). Thereafter, the temperature of the oven may be reduced to from 100° C. to 140° C. (e.g., 120° C.) for from 1.5 hours to 2.5 hours (e.g., 2 hours). Thereafter, the temperature of the oven may be further reduced to from 60° C. to 100° C. (e.g., 80° C.).

According to some embodiments, the molding material may be preheated prior to being supplied to mold assembly 44. The molding material may be any moldable elastomeric material, such as, for example, polyurethane such as described previously herein, natural rubber, synthetic rubber, or any combinations thereof. The molding material may include any known additives for improvement of performance and/or appearance. Prior to or during preheating, any known preparation methods such as, for example, mixing, agitating, degassing, and/or sample testing may be performed. The molding material may be preheated to from 30° C. to 50° C. (e.g., 40° C.).

The temperature of the interior of mold assembly 44 may be measured, for example, using an infrared gun or other known methods. According to some embodiments, it may be desirable for the temperature of the interior to be greater than room temperature (e.g., greater than about 24° C.), but less than from 70° C. to 90° C. (e.g., less than about 80° C.) prior to supplying the preheated molding material to the interior of mold assembly 44.

According to some embodiments, the molding material may be added to mold assembly 44 via apertures 46 in upper face plate 52 of upper mold portion 42. According to some embodiments, the interior of mold assembly 44 should be substantially or completely filled. It may be desirable to fill mold assembly 44 expeditiously in order to take advantage of the preheating of mold assembly 44 and the molding material, for example, to reduce the likelihood of the molding material cooling to a temperature below a desired level. For example, the molding material may be added to mold assembly 44 at a rate of at least 180 lbs. per minute (e.g., at least 220 lbs. per minute, for example, 510 lbs. per minute). After mold assembly 44 has been filled, caps may be secured over apertures 46.

According to some embodiments, the oven may be heated to a temperature ranging from 180° C. to 260° C. (e.g., 220° C.), for example, while mold assembly 44 is being filled. When mold assembly 44 has been filled and the oven reaches the desired temperature, the filled mold assembly 44 may be moved into the oven. Thereafter, the filled mold assembly 44 may be heated in the oven for a first predetermined period time at a first temperature. For example, the filled mold assembly 44 may be heated at a first temperature, such that the temperature of the molding material ranges from 180° C. to 260° C. (e.g., 220° C.) for from 1 hour to 2 hours (e.g., 1 hour and 40 minutes). According to some embodiments, thereafter the temperature of the oven may be reduced so that the filled mold assembly is heated for a second predetermined period of time at a second temperature, such that the molding material has a temperature of from 130° C. to 170° C. (e.g., 150° C.) for from 15 hours to 20 hours (e.g., 18 hours).

According to some embodiments, after the second predetermined period of time elapses, the filled mold assembly 44 may be removed from the oven. Thereafter, the molded tire may be removed from mold assembly 44 by separating upper mold portion 42 from lower mold portion 40 (e.g., via a lift apparatus), and separating the molded tire from lower mold portion 40. According to some embodiments, the molded tire may be removed from the mold before the mold and/or molded tire cool significantly.

### INDUSTRIAL APPLICABILITY

The exemplary tires 24 disclosed herein may be used on machines configured to travel across terrain. For example, such machines may include any type of ground-borne vehicle, such as, for example, an automobile, a truck, an agricultural vehicle, and/or a construction vehicle, such as, for example, a wheel loader, a dozer, a skid-steer loader, an excavator, a grader, an on-highway truck, an off-highway truck, and/or any other vehicle type known to a person skilled in the art. In addition to self-propelled machines, the machine may be any device configured to travel across terrain via assistance or propulsion from another machine.

According to some embodiments, tire 24, including inner circumferential portion 26, outer circumferential portion 28, tread portion 32, and support structure 34, may be configured to provide a desired amount of traction and cushioning between a machine and the terrain. For example, support structure 32 may be configured to support the machine in a loaded, partially loaded, and empty condition, such that a desired amount of traction and/or cushioning is provided, regardless of the load.

According to some embodiments, the reinforced tire may permit designs that provide a desired level of cushioning and radial compliance without exceeding the material limits of the molded material forming the tire. For example, a desired level of radial compliance and support may be provided by designing the cavities of the tire to provide the desired level of radial compliance and/or support. The synthetic reinforcing material may be provided at locations of the tire that may be subjected to the highest stress and/or strain levels to support the molded material at those locations. For example, the synthetic reinforcing material may be located in areas associated with the cavities, which may generally be subjected to the highest levels of stress and/or strain. This may reduce the likelihood or prevent the local stress and/or strain from exceeding the stress and strain limits of the molded material. This may, in turn, reduce the likelihood or prevent cracking in the molded material and may improve the service life of the tire.

It will be apparent to those skilled in the art that various modifications and variations can be made to the exemplary tires, systems, and methods. Other embodiments will be apparent to those skilled in the art from consideration of the specification and practice of the exemplary disclosed embodiments. It is intended that the specification and examples be considered as exemplary only, with a true scope being indicated by the following claims and their equivalents.

What is claimed is:

1. A non-pneumatic tire comprising:
an inner circumferential portion configured to be coupled to a hub;
an outer circumferential portion radially spaced from the inner circumferential portion; and
a support structure extending between the inner circumferential portion and the outer circumferential portion and coupling the inner circumferential portion to the outer circumferential portion,
wherein the support structure at least partially defines a first axial side of the tire and a second axial side of the tire opposite the first axial side of the tire,
wherein the support structure has a plurality of cavities at least partially extending between the first axial side of the tire and the second axial side of the tire, and
wherein at least some of the cavities are reinforced with a synthetic reinforcing material.

2. The tire of claim 1, wherein the synthetic reinforcing material includes synthetic reinforcing fibers.

3. The tire of claim 1, wherein the synthetic reinforcing material includes para-aramid synthetic fibers.

4. The tire of claim 1, wherein the at least some cavities have a surface, and wherein the synthetic reinforcing material is at least partially embedded in the surface of the at least some cavities.

5. The tire of claim 1, wherein the at least some cavities have a surface, and wherein the synthetic reinforcing material is substantially coextensive with the surface of the at least some cavities.

6. The tire of claim 1, wherein the at least some cavities have a surface, and wherein at least a portion of the synthetic reinforcing material is below the surface of the at least some cavities.

7. The tire of claim 1, wherein the at least some cavities define an axial cross-section that varies at points between the first axial side of the tire and the second axial side of the tire.

8. The tire of claim 7, wherein the axial cross-section has a shape and an area, and wherein at least one of the shape and the area varies at points between the first axial side and the second axial side.

9. The tire of claim 1, wherein the support structure defines an axially intermediate region between the first axial side of the tire and the second axial side of the tire, and wherein a first portion of the at least some cavities defines an axial cross-section having an area that decreases as the least some cavities extend from the first axial side toward the axially intermediate region, and a second portion of the at least some cavities defines an axial cross-section having an area that decreases as the least some cavities extend from the second axial side toward the axially intermediate region.

10. A system for molding a non-pneumatic tire, the system comprising:
a lower mold portion including a lower face plate configured to provide a lower relief corresponding to a first side of the tire, and a plurality of lower projections extending from the lower face plate and configured to correspond to cavities in the first side of the tire;
an upper mold portion configured to be coupled to the lower mold portion, the upper mold portion including an upper face plate configured to provide an upper relief corresponding to a second side of the tire, and a plurality of upper projections extending from the upper face plate and configured to correspond to cavities in the second side of the tire; and
synthetic reinforcing material associated with at least some of the plurality of lower projections and the plurality of upper projections, wherein the synthetic reinforcing material is configured to reinforce at least some of the cavities of the tire.

11. The system of claim 10, wherein the synthetic reinforcing material includes synthetic reinforcing fibers.

12. The system of claim 10, wherein the reinforcing material includes para-aramid synthetic fibers.

13. The system of claim 10, wherein the synthetic reinforcing material includes sleeves including synthetic reinforcing fibers, and wherein the sleeves are configured to be mounted over the at least some lower and upper projections.

14. The system of claim 13, wherein the sleeves further include a polyurethane tube, and wherein the synthetic reinforcing fibers are at least partially embedded in the polyurethane tube.

15. The system of claim 10, wherein the synthetic reinforcing material substantially covers the at least some lower and upper projections.

16. A method of forming a molded non-pneumatic tire, the method comprising:
providing a lower mold portion including a lower face plate configured to provide a lower relief corresponding to a first side of the tire, and a plurality of lower projections extending from the lower face plate and configured to correspond to cavities in the first side of the tire;
providing an upper mold portion including an upper face plate configured to provide an upper relief corresponding to a second side of the tire, and a plurality of upper projections extending from the upper face plate and configured to correspond to cavities in the second side of the tire;
associating synthetic reinforcing material with at least some of the lower projections and upper projections;
placing the upper mold portion onto the lower mold portion to create a mold assembly having an interior;
heating a molding material;
transferring the heated molding material into the interior of the mold assembly, such that the interior is substantially filled;
curing the heated molding material;
separating the upper mold portion from the lower mold portion; and
separating the tire from the lower mold portion, such that the synthetic reinforcing material remains in the tire following separation of the tire from the lower and upper mold portions.

17. The method of claim 16, wherein associating the synthetic reinforcing material with at least some of the lower and upper projections includes mounting the synthetic reinforcing material on the at least some lower and upper projections.

18. The method of claim 17, wherein the synthetic reinforcing material includes sleeves including synthetic reinforcing fibers, and the method further includes sliding the sleeves over the at least some lower and upper projections.

19. The method of claim 18, wherein the sleeves further include a polyurethane tube, and wherein the synthetic reinforcing fibers are at least partially embedded in the polyurethane tube.

20. The method of claim 17, wherein mounting the synthetic reinforcing material includes securing the synthetic reinforcing material to the at least some lower and upper projections via adhesive.
